(19) United States
(12) Patent Application Publication
(10) Pub. No.: US 2018/0180124 A1
(43) Pub. Date: Jun. 28, 2018

(54) MODIFIED VEHICLE-USED BRAKE DISC COMPOSITE STRUCTURE

(71) Applicant: D.MAG (KUNSHAN) NEW MATERIAL TECHNOLOGY CO., LTD., Suzhou (CN)

(72) Inventor: Jibing Tu, Suzhou (CN)

(21) Appl. No.: 15/455,012

(22) Filed: Mar. 9, 2017

(30) Foreign Application Priority Data
Dec. 23, 2016 (CN) 201611203080.6

(51) Int. Cl. F16D 65/12

(52) U.S. Cl. CPC F16D 65/125; F16D 2065/132; F16D 65/128

(57) ABSTRACT

A modified vehicle-used brake disc composite structure, comprising an inner ring piece made from a lightweight metal and a disc body having a high rigidity, wear-resistance and heat-resistance; the inner surface of the inner ring piece is equally divided and extends to form a plurality of arm-like fixing portions; a ring piece is disposed at the outer edge of the inner ring piece; the two side surfaces of the ring piece respectively form a first engaging surface; the disc body is provided with a plurality of annular-shaped heat-dissipation holes; a second engaging surface is disposed on one side of the disc body; the two side surfaces of the inner ring piece are respectively pressed by the two disc bodies, enabling the second engaging surfaces to be respectively fixed to the first engaging surfaces via friction welding method so as to form the brake disc.

### TECHNICAL FIELD OF THE INVENTION

The present invention relates to the technical field of vehicles, and more particularly, to a modified vehicle-used brake disk composite structure.

### BACKGROUND OF THE INVENTION

To control the riding speed and braking of a bicycle, the braking device uses a rubber module to tightly press the bicycle rim to stop the bicycle. The traditional braking device has evolved into a disk brake device nowadays. In the prior art, the disk brake device usually adopts a flat brake disk which is mounted at one side of the hub of the bicycle rim. Consequently, the braking device can control the caliper to strongly rub against the brake disc to stop the bicycle without damaging the bicycle rim. However, the brake disc is a quick-wear part, which needs to be frequently replaced due to the abrasion of the caliper.

The brake disc made from stainless steel has a heavier weight, which affects the riding speed in a certain degree. To achieve a lightweight design, the traditional brake disc is usually made from aluminum alloy having a smaller density. Although aluminum alloy has a light weight, its rigidity is decreased accordingly. Furthermore, the fatigue performance of aluminum alloy is far lower than steel. A steel-made brake disc can bear an infinite cyclic load. However, the fatigue limit of aluminum alloy is near zero, meaning that a very small cyclic load can damage the brake disc made from aluminum alloy. Consequently, the functional life of the brake disc can be sharply decreased if the rigidity and the wear-resistance are not high enough.

### SUMMARY OF THE INVENTION

The purpose of the present invention is to solve the shortcomings in the prior art, and provide a modified vehicle-used brake disc composite structure.

To achieve the above purpose, the present invention adopts the following technical solution:

A modified vehicle-used brake disc composite structure, comprising an inner ring piece made from a lightweight metal and a disc body having a high rigidity, wear-resistance and heat-resistance. The inner surface of the inner ring piece is equally divided and extends to form a plurality of arm-like fixing portions. A ring piece is disposed at the outer edge of the inner ring piece. The two side surfaces of the ring piece respectively form a first engaging surface. The disc body is provided with a plurality of annular-shaped heat-dissipation holes. A second engaging surface is disposed on one side of the disc body. The two side surfaces of the inner ring piece are respectively pressed by the two disc bodies, enabling the second engaging surfaces to be respectively fixed to the first engaging surfaces via friction welding method to form the brake disc.

In another aspect of the present invention, the first engaging portion is disposed at the outer edge of the two sides of the inner ring piece. A hole is disposed on the first engaging portion in the radial direction, and an inner ring hole is disposed in the middle of the disc body. A plurality of the second engaging portions, which is convex-shaped, is integrally disposed in the inner ring hole of the disc body. A protruding portion is disposed on one side of the second engaging portion in the radial direction, enabling the two side surfaces of the inner ring piece to be correspondingly pressed by the two disc bodies. The second engaging portions of the two disc bodies are respectively engaged with the first engaging portions, and the protruding portions of each side are respectively inserted into the corresponding holes, enabling the second engaging surfaces of the two disc bodies to be respectively fixed to the first engaging surfaces of the corresponding sides via friction welding method.

In another aspect of the present invention, a side edge is disposed on one side surface of the disc body near the inner ring piece. The second engaging surface is tightly attached to the first engaging surface of the inner ring piece, and the corresponding side edges of the two sides are contacted, enabling the second engaging surfaces of the two disc bodies and the first engaging surfaces of the two sides of the inner ring piece to be fixed via friction welding method, and the corresponding side edges to be fixed via friction welding method.

In another aspect of the present invention, the inner ring piece is made from a lightweight metal such as aluminum alloy, magnesium alloy or titanium alloy.

In another aspect of the present invention, the disc body is made from stainless steel.

In another aspect of the present invention, the disc body is made from heat-treated steel or iron.

In another aspect of the present invention, the disc body is made from a metal coated with Teflon or other wear-resistant material.

The present invention relates to a modified vehicle-used brake disc composite structure. The brake disc comprises an inner ring piece made from a lightweight metal and a disc body. The inner side of the inner ring piece extends to form a plurality of arm-like fixing portions. A ring piece is disposed at the outer edge of the inner ring piece, and the two side surfaces of the ring piece are respectively provided with a first engaging surface. The disc body is made from a material having a high rigidity, heat-resistance and wear-resistance. A second engaging surface is disposed on one side surface of the disc body. The side surfaces of the inner ring piece are respectively pressed by two disc bodies, enabling the second engaging surfaces to be correspondingly fixed to the first engaging surfaces via friction welding method to form the brake disc of the present invention. The lightweight inner ring piece can effectively reduce the overall weight of the brake disc, and the disc body can improve the wear-resistance when the disc body is frequently rubbed with the caliper, which greatly improves the rigidity and prolongs the functional life of the brake disc. Thus, the present invention is creative and innovative.

Compared with the prior art, the present invention has the following advantages:

The two sides of the inner ring piece are tightly pressed by two disc bodies, thereby reducing the overall weight of the brake disc due to the lightweight inner ring piece. Furthermore, the disc body, which is in contact with the caliper, is made from a material having a high rigidity, heat-resistance and wear-resistance, which prolongs the functional life and improves the rigidity of the brake disc. Consequently, the replacement frequency of the brake disc can be reduced, increasing the safety of the present invention.

Furthermore, a plurality of the inwardly-recessed first engaging portions is disposed at the outer edge of the two sides of the inner ring piece. The first engaging portion is provided with a hole in the radial direction. A plurality of the convex-shaped second engaging portions is integrally disposed on the disc body near the inner ring piece. A protruding portion is disposed on one side of the second engaging portion in the radial direction. During assembly, the second engaging portions are respectively embedded into the first engaging portions, and the protruding portions are respectively inserted into the holes, enabling the two disc bodies to be fixed to the first engaging surfaces of the inner ring piece via friction welding method. Through the engagement between the first engaging portion and the second engaging portion, and the engagement between the protruding portions and the holes, the twisting force is greatly improved to achieve a stable structure.

Moreover, a side edge is disposed on the side surface of the disc body near the inner ring piece in the radial direction. When the second engaging surface is tightly attached to the first engaging surface, the side edges of the two sides contact each other, which are fixed via friction welding method. Thus, the binding force is greatly improved, enabling the present invention to be stably assembled.

### BRIEF DESCRIPTION OF THE DRAWINGS

To clearly expound the present invention or technical solution, the drawings and embodiments are hereinafter combined to illustrate the present invention. Obviously, the drawings are merely some embodiments of the present invention and those skilled in the art can associate themselves with other drawings without paying creative labor.

FIG. 1 is a perspective view of the first embodiment of the present invention.

FIG. 2 is an exploded perspective view of the first embodiment of the present invention.

FIG. 3 is a front view of the first embodiment of the present invention.

FIG. 4 is a sectional view taken along line 4-4 of FIG. 3.

FIG. 5 is a perspective view of the second embodiment of the present invention.

FIG. 6 is an exploded perspective view of the second embodiment of the present invention.

FIG. 7 is a front view of the second embodiment of the present invention.

FIG. 8 is a sectional view taken along line 8-8 of FIG. 7.

### DETAILED DESCRIPTION OF THE INVENTION

Drawings and detailed embodiments are combined hereinafter to elaborate the technical principles of the present invention.

### Embodiment 1

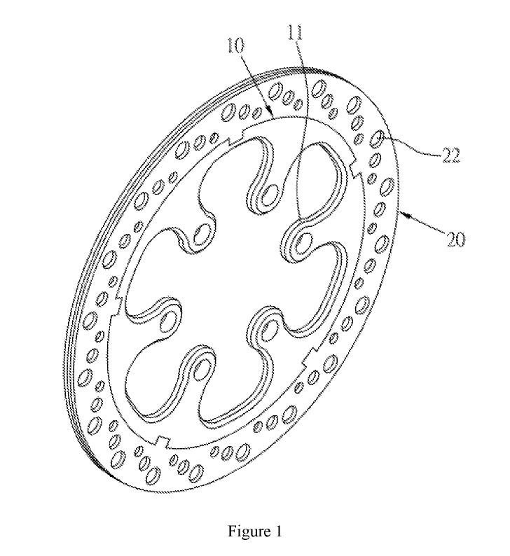

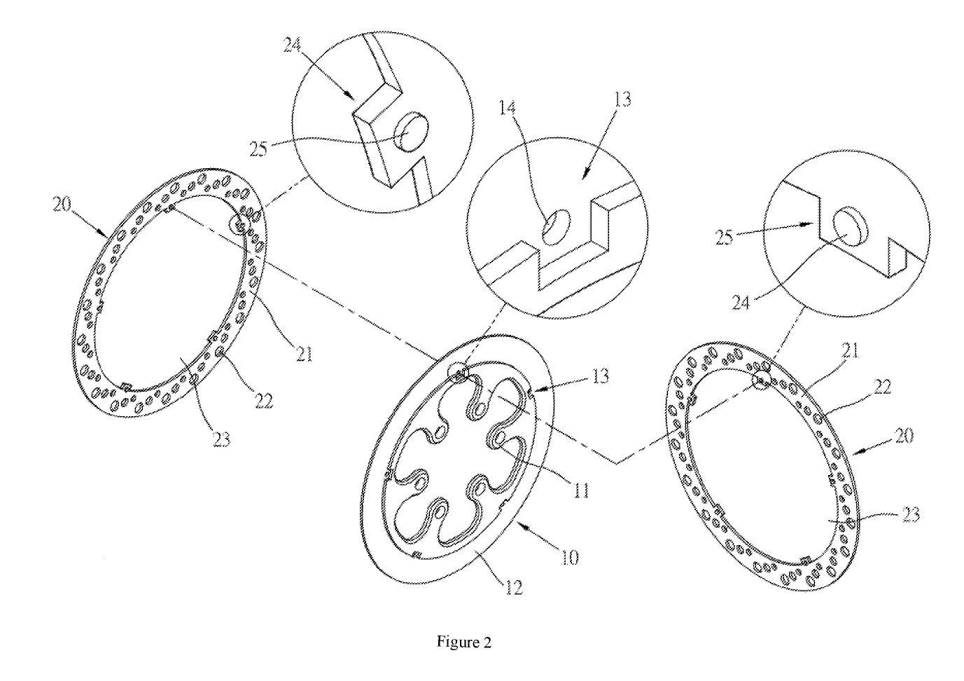

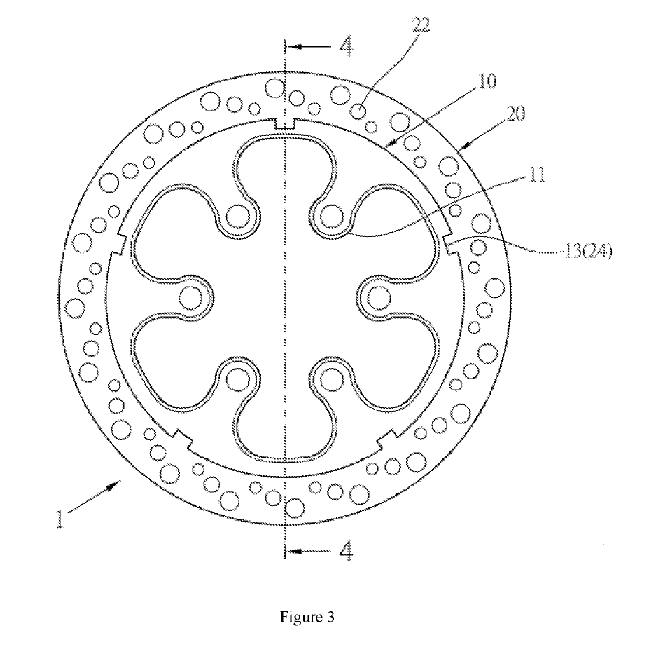

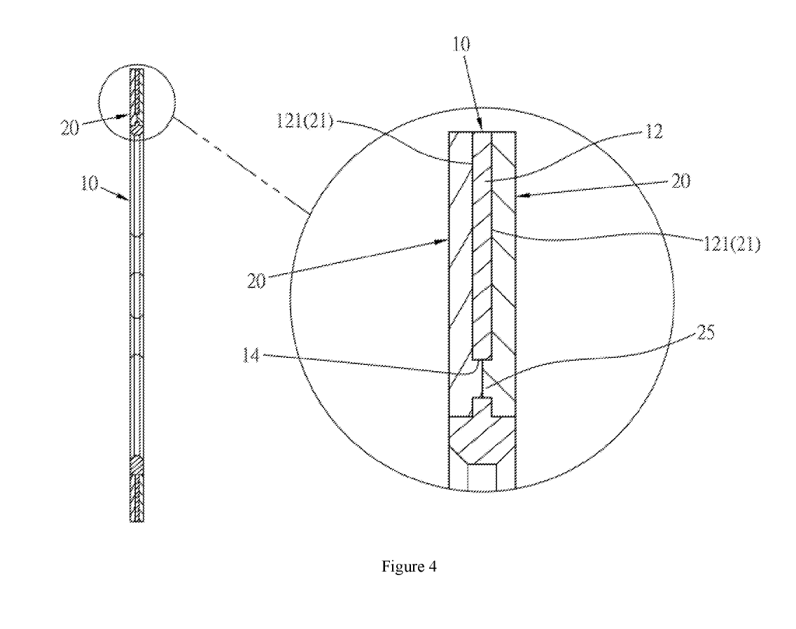

As shown in FIGS. 1-4, the brake disc 1 comprises an inner ring piece 10 and two disc bodies 20. The inner surface of the inner ring piece 10 is equally divided and extends to form a plurality of arm-like fixing portions 11 in the radial direction, through which the brake disc 1 can be mounted to the frame of the bicycle. A ring piece 12 is disposed at the outer edge of the inner ring piece 10, and a protruding step structure is disposed between the outer edge of the inner ring piece 10 and the ring piece 12. The two side surfaces of the ring piece 12 are respectively provided with a first engaging surface 121. The outer edge of the two sides of the inner ring piece 10 is provided with a plurality of the inwardly-recessed first engaging portions 13. The first engaging portion 13 is provided with a hole 14 in the radial direction. The inner ring piece 10 is made from a lightweight metal such as aluminum alloy, magnesium alloy, or titanium alloy.

The disc body 20 is annular-shaped. A second engaging surface 21 is disposed on one side of the disc body 20. A plurality of heat-dissipation holes is disposed on the disc body 20, and an inner ring hole 23 is disposed in the middle of the disc body 20. A plurality of the convex-shaped second engaging portions 24 is integrally disposed in the inner ring hole 23 of the disc body 20. A protruding portion 25 is disposed on one side of the second engaging portion 24 in the radial direction. The disc body 20 is made from a material having a high rigidity, heat-resistance and wear-resistance, such as stainless steel, heat-treated steel/iron, or metal coated with Teflon or other wear-resistant material, which can improve the wear-resistance when the disc body 20 is rubbed with the caliper to prolong the functional life of the brake disc.

During assembly, the two side surfaces of the inner ring piece 10 are correspondingly pressed by the two disc bodies, enabling the second engaging portions 24 of the two disc bodies 20 to be respectively embedded into the first engaging portion, and each protruding portion 25 to be respectively inserted into the corresponding holes 14. The second engaging surfaces 21 of the two disc bodies 20 are respectively fixed to the first engaging surfaces 121 of the two sides of the inner ring piece 10. Thus, the two sides of the inner ring piece 10 are tightly pressed by the two disc bodies 20 to form the brake disc 1.

The two disc bodies 20 are fixed to the two sides of the inner ring piece 10 via friction welding method to form the brake disc 1. The overall weight of the brake disc 1 can be reduced due to the inner ring piece 10 made from a lightweight metal. Furthermore, the disc body 20 has a high rigidity, heat-resistance and wear-resistance, effectively prolonging the functional life of the disc body 20. The first engaging portion 13 is engaged with the second engaging portion 14, which can improve the twisting force and stabilize the integral structure. Thus, the present invention is convenient and innovative.

During assembly, the two disc bodies respectively press the two sides of the inner ring piece 10. The second engaging portions 24 of the two disc bodies 20 are respectively embedded into the first engaging portions 13, and each of the protruding portions 25 are respectively inserted into the corresponding holes 14, enabling the second engaging surfaces 21 of the two disc bodies 20 to be fixed to the two first engaging surfaces 121 of the inner ring piece 10 via friction welding method.

### Embodiment 2

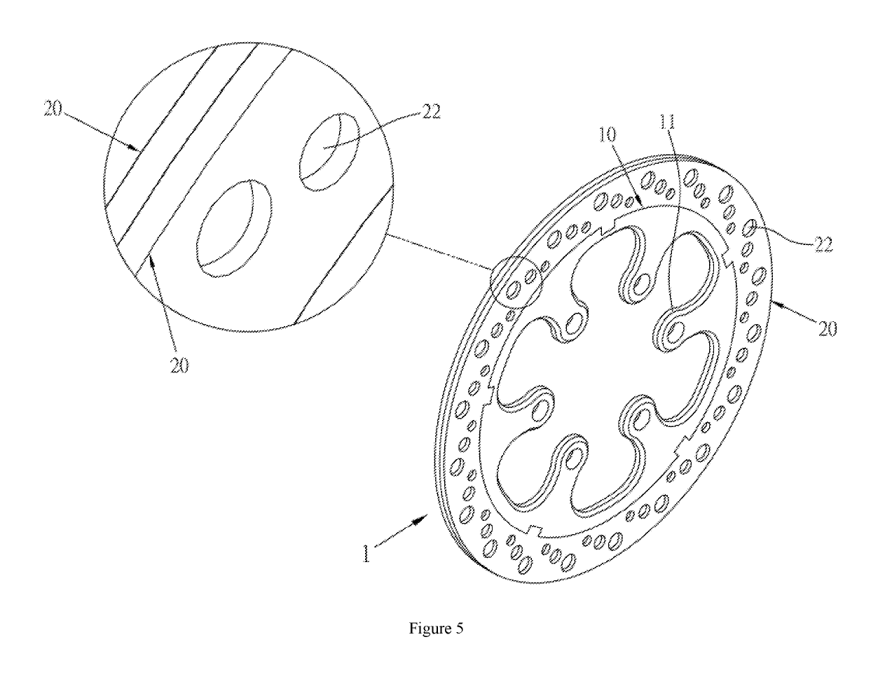

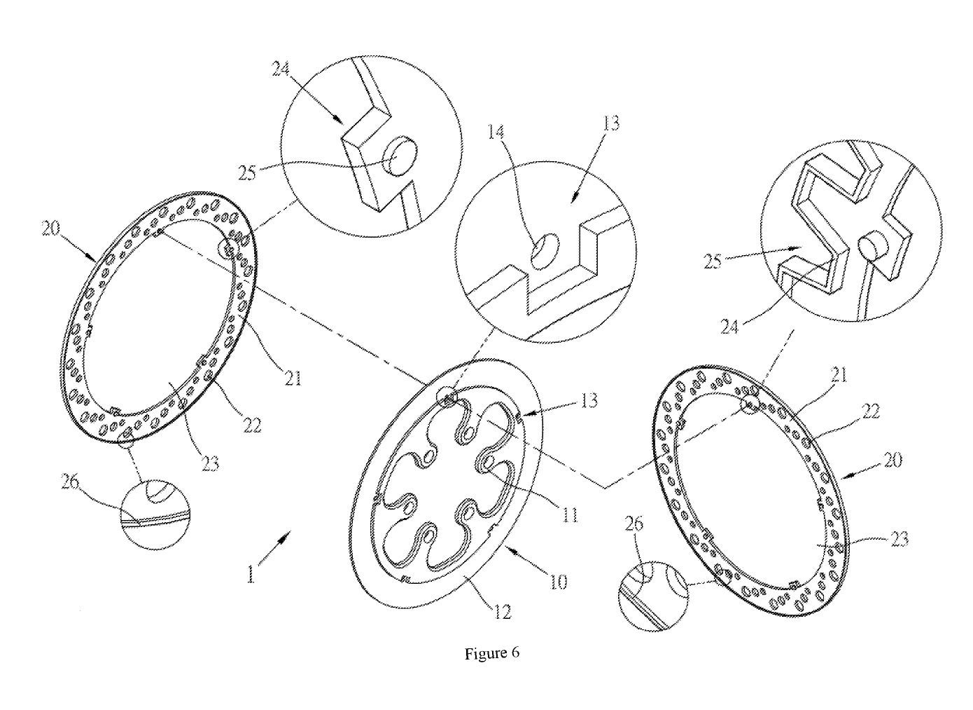

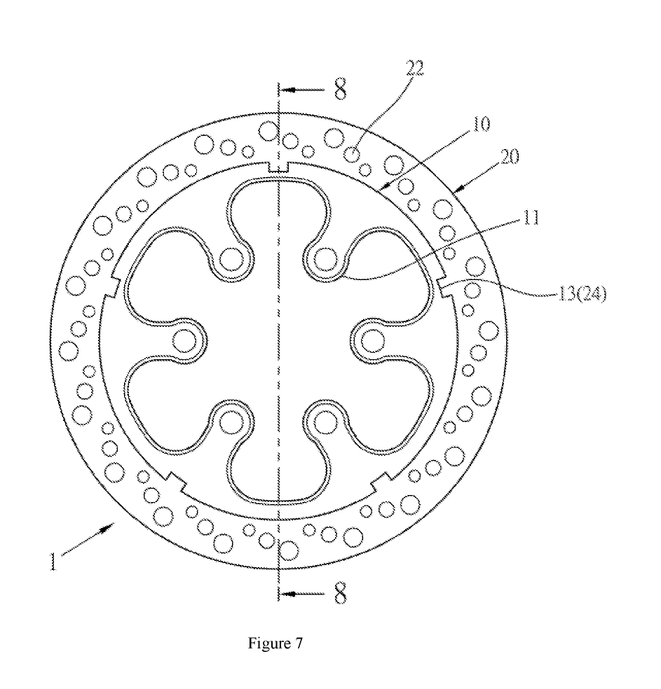

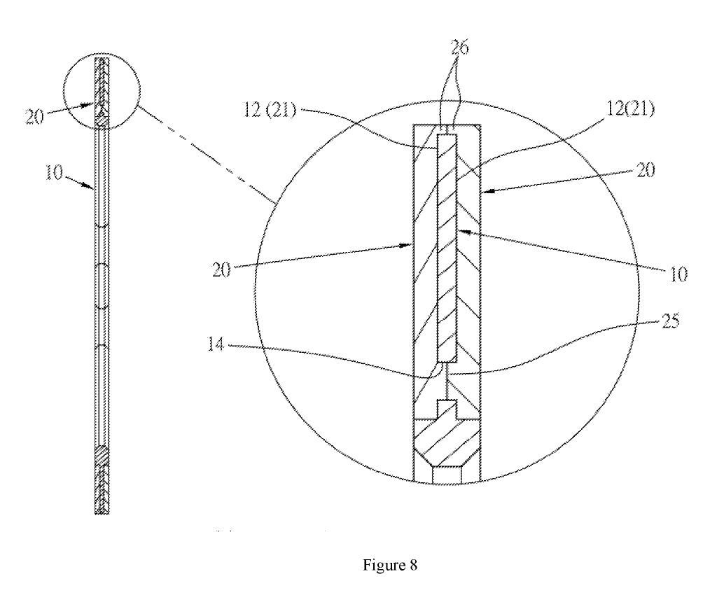

As shown in FIGS. 5-8, a side edge 26 is disposed along one side surface of the disc body 20 near the inner ring piece 10. The second engaging surface 21 is tightly attached to the first engaging surface 121 of the inner ring piece 10, and the side edges 26 of the two sides contact each other, which are fixed via friction welding method so as to improve the binding force and the binding stability.

During use, the two side surfaces of the inner ring piece 10 are respectively pressed by the two disc bodies 20. The overall weight of the brake disc 1 can be reduced due to the inner ring piece 10 made from a lightweight metal. The disc body 20 has a high rigidity, heat-resistance and wear-resistance, which can improve the rigidity of the disc body 20 and reduce the replacement frequency of the brake disc 1. Thus, the user can feel safe when using the present invention.

A plurality of the inwardly-recessed first engaging portions 13 is disposed at the outer edge of the two sides of the inner ring piece 10. Each of the first engaging portions 13 are provided with a hole 14 in the radial direction. A plurality of the second engaging portions 24 is integrally disposed in the inner ring hole 23 of the disc body 20, and one side of each of the second engaging portions 24 is provided with a protruding portion 25 in the radial direction. During assembly, the corresponding second engaging portions 24 of the two disc bodies 20 are respectively embedded into the first engaging portions 13, and each of the protruding portions 25 are respectively inserted into the corresponding holes 14, enabling the second engaging surfaces 21 of the two disc bodies 20 to be respectively fixed to the first engaging surfaces 121 of the two sides of the inner ring piece 10 via friction welding method. Through the engagement between the first engaging portion 13 and the second engaging portion 24, and the engagement between the protruding portion 25 and the hole 14, the twisting force is greatly improved to stabilize the integral structure. A side edge 26 is disposed on one side surface of the disc body 20 near the inner ring piece 10. The second engaging surface 21 is tightly attached to the first engaging surface 121 of the inner ring piece 10, and the side edges of the two sides are contacted, which are fixed via friction welding method to improve the binding force and stabilize the structure.

The previous descriptions are of preferred examples for implementing the invention, and the scope of the invention should not necessarily be limited by this description. The scope of the present invention is defined by the claims.

1. A modified vehicle-used brake disc composite structure, comprising:
an inner ring piece made from a lightweight metal, and
a disc body having a high rigidity, wear-resistance and heat-resistance, wherein the inner surface of the inner ring piece is equally divided and extends to form a plurality of arm-like fixing portions, wherein a ring piece is disposed at the outer edge of the inner ring piece, wherein the two side surfaces of the ring piece form a first engaging surface, wherein the disc body is provided with a plurality of annular-shaped heat-dissipation holes, wherein a second engaging surface is disposed on one side of the disc body, wherein the two side surfaces of the inner ring piece are respectively pressed by the two disc bodies, enabling the second engaging surfaces to be respectively fixed to the first engaging surfaces via friction welding method to form the brake disc.

2. The modified vehicle-used brake disc composite structure of claim 1, wherein a first engaging portion, which is inwardly-recessed, is disposed at the outer edge of the two sides of the inner ring piece, wherein a hole is disposed on the first engaging portion in the radial direction, and an inner ring hole is disposed in the middle of the disc body, wherein a plurality of the second engaging portions, which is convex-shaped, is integrally disposed in the inner ring hole of the disc body, wherein a protruding portion is disposed on one side of the second engaging portion in the radial direction, enabling the two side surfaces of the inner ring piece to be correspondingly pressed by the two disc bodies, wherein the second engaging portions of the two disc bodies are respectively engaged with the first engaging portions, and the protruding portions of each side are respectively inserted into the corresponding holes, enabling the second engaging surfaces of the two disc bodies to be respectively fixed to the first engaging surfaces on the corresponding side via friction welding method.

3. The modified vehicle-used brake disc composite structure of claim 1, wherein a side edge is disposed on one side surface of the disc body near the inner ring piece, wherein the second engaging surface is tightly attached to the first engaging surface of the inner ring piece, and the corresponding side edges of the two sides contact each other, enabling the second engaging surfaces of the two disc bodies and the first engaging surfaces of the two sides of the inner ring piece to be fixed via friction welding method, and the corresponding side edges to be fixed via friction welding method.

4. The modified vehicle-used brake disc composite structure of claim 1, wherein the inner ring piece is made from a lightweight metal such as aluminum alloy, magnesium alloy or titanium alloy.

5. The modified vehicle-used brake disc composite structure of claim 1, wherein the disc body is made from stainless steel.

6. The modified vehicle-used brake disc composite structure of claim 1, wherein the disc body is made from heat-treated steel or iron.

7. The modified vehicle-used brake disc composite structure of claim 1, wherein the disc body is made from a metal coated with Teflon or other wear-resistant material.
